(19) United States
(12) Patent Application Publication
(10) Pub. No.: US 2010/0253623 A1
(43) Pub. Date: Oct. 7, 2010

(54) REMOTE CONTROL, IMAGING DEVICE, METHOD AND SYSTEM FOR THE SAME

(75) Inventors: Qiang Wei, Beijing (CN); Mitsuru Kaji, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/304,056

(22) PCT Filed: Mar. 1, 2007
(86) PCT No.: PCT/CN07/00645

§ 371 Date: Jun. 7, 2010

(30) Foreign Application Priority Data
Mar. 1, 2006 (CN) 200610019873.2

(51) Int. Cl. G06F 3/033

(52) U.S. Cl. 345/158

(57) ABSTRACT

A remote control, an imaging device, a method and a system for the same are provided to realize the functions such as channel selection of programs, character input, etc. The remote control comprises: an operation means having multiple keys, an ultrasonic and radio signal transmitting means for transmitting radio signals and ultrasonic signals while one of the said multiple keys is operated to map the position of the remote control into a cursor displayer on a screen, and a control means for controlling the said operation means and the said ultrasonic and radio signal transmitting means.

### FIELD OF THE INVENTION

The present invention relates to a remote control, an imaging device, a method and a system for the same, and more specifically to a remote control, an imaging device, a method and a system for the same based on ultrasonic and radio signal ranging in order to realize the functions such as channel selection of TV programs, character input, etc.

### BACKGROUND OF THE INVENTION

With the development of digital TV technology and the increase of digital TV broadcast programs, digital TV has been gradually made entry into our life. An important characteristic of digital TV is that we can choose our favorite programs at any time. However, for the common users who have been accustomed to traditional TV remote control operation, it is not easy to input and specify their favorite programs. Users often need to choose certain function keys from a large number of densely-arranged keys on a remote control. To complete the operation, users unfamiliar with the operation often have to constantly find and confirm the key positions, and then look up the screen to confirm the selection result (for example, the change of TV channels, inputted reservation time, etc.). Meanwhile, as digital TV technology progresses, many new functions require users to input characters, which brings forward a greater challenge to a traditional remote control. All these problems due to a remote control affect seriously the attraction of digital TV to the common users.

### SUMMARY OF THE INVENTION

In order to solve the above problems, it is an object of the present invention to provide a remote control, a method and a system for the same based on ultrasonic and radio signal ranging such that users are facilitated to utilize remote control to control imaging devices such as TV set, computer or projector.

In an aspect of the present invention provided a remote control comprising an operation means having a plurality of keys, an ultrasonic and radio signal transmitting means for transmitting radio signals and ultrasonic signals while one of the plurality of keys is operated so as to map the position of the remote control into a cursor displayed on a screen, and a control means for controlling the operation means and the ultrasonic and radio signal transmitting means.

According to an embodiment of the present invention, the operation means includes an initializing key, and when the initializing key is pressed, the current position of the remote control is mapped into the central point of the screen.

According to an embodiment of the present invention, the ultrasonic and radio signal transmitting means includes a radio signal transmitting unit for transmitting radio signals under the control of the control means, and an ultrasonic signal transmitting unit for transmitting ultrasonic signals in synchronization with the radio signals under the control of the control means.

In another aspect of the present invention provided an imaging device comprising at least three ultrasonic and radio signal receiving means configured at the predefined position in the same plane as a screen or in the plane parallel to the screen for receiving radio signals and ultrasonic signals transmitted from a remote control, a timing means for starting timing when the ultrasonic and radio signal receiving means receives radio signals and stopping timing when the ultrasonic and radio signal receiving means receives ultrasonic signals so as to obtain a time difference corresponding to the respective ultrasonic and radio signal receiving means, a calculation means for calculating the spatial coordinate of the remote control and the projected coordinate of the spatial coordinate on the screen based on the time difference, and a display means for associating the projected coordinate with the cursor displayed on the screen.

According to an embodiment of the present invention, the calculation means includes and the remote control based on the time difference a distance calculation unit for calculating the distance between the respective ultrasonic and radio signal receiving means and the remote control based on the time difference corresponding to the respective ultrasonic and radio signal receiving means, a coordinate calculation unit for calculating the spatial coordinate of the remote control based on the distance between the respective ultrasonic and radio signal receiving means and the remote control, and a coordinate projection calculation unit for calculating the projected coordinate on the screen based on the spatial coordinate of the remote control.

According to an embodiment of the present invention, the distance calculation unit calculates the distance based on the following expression:

Dᵢ=T_{Di}×V_{sound}

wherein T_{Di} represents the time taken to transmit ultrasonic signals from the remote control to the respective ultrasonic and radio signal receiving means, and V_{sound} represents the velocity of ultrasonic wave.

According to an embodiment of the present invention, when the distance between the remote control and the screen increases, the display means expands the proportion of the moving distance of the screen cursor with respect to the actual moving distance of the remote control.

According to an embodiment of the present invention, when the distance between the remote control and the screen decreases, the display means contracts the proportion of the moving distance of the screen cursor with respect to the actual moving distance of the remote control.

According to an embodiment of the present invention, when the distance between the remote control and the screen increases, the display means displays menu in larger font.

According to an embodiment of the present invention, the distance between the remote control and the screen decreases, the display means displays menu in smaller font.

According to an embodiment of the present invention, when the distance between the remote control and the screen suddenly increases, the display means displays menu in larger font.

According to an embodiment of the present invention, the distance between the remote control and the screen suddenly decreases, the display means displays menu in smaller font.

In a further aspect of the present invention provided a remote control system comprising the remote control and the imaging device.

In a further aspect of the present invention provided A remote control method used in a system comprising a remote control and an imaging device, wherein the remote control includes a ultrasonic and radio signal transmitter, and the imaging device is configured with at least three ultrasonic and radio signal receivers at the predefined position in the same plane as the screen or in the plane parallel to the screen, the method comprises the steps of: transmitting simultaneously both radio signals and ultrasonic signals from the ultrasonic and radio signal transmitter, starting timing when the ultrasonic and radio signal receivers receive radio signals and stopping timing when the ultrasonic and radio signal receivers receive ultrasonic signals so as to obtain the time difference corresponding to the respective ultrasonic and radio signal receivers, calculating the spatial coordinate of the remote control and the projected coordinate of the spatial coordinate on the screen based on the time difference, and associating the projected coordinate with the cursor displayed on the screen.

According to an embodiment of the present invention, the step of calculating the spatial coordinate of the remote control and the projected coordinate of the spatial coordinate on the screen based on the time difference includes: calculating the distance between the respective ultrasonic and radio signal receivers and the remote control based on the time difference corresponding to the respective ultrasonic and radio signal receivers, calculating the spatial coordinate of the remote control based on the distance between the respective ultrasonic and radio signal receivers and the remote control, and calculating the projected coordinate on the screen based on the spatial coordinate of the remote control.

According to an embodiment of the present invention, the calculation of the distance is based on the following expression:

Dᵢ=T_{Di}×V_{sound}

wherein T_{Di} represents the time for transmitting ultrasonic signals from the remote control to the respective ultrasonic and radio signal receivers, and V_{sound} represents the velocity of ultrasonic wave.

According to an embodiment of the present invention, the method further comprises the step of expanding the proportion of the moving distance of the screen cursor with respect to the actual moving distance of the remote control when the distance between the remote control and the screen increases.

According to an embodiment of the present invention, the method further comprises the step of contracting the proportion of the moving distance of the screen cursor with respect to the actual moving distance of the remote control when the distance between the remote control and the screen decreases.

According to an embodiment of the present invention, the method further comprises the step of displaying menu in larger font when the distance between the remote control and the screen increases.

According to an embodiment of the present invention, the method further comprises the step of displaying menu in smaller font when the distance between the remote control and the screen decreases.

According to an embodiment of the present invention, the method further comprises the step of displaying menu in larger font when the distance between the remote control and the screen suddenly increases.

According to an embodiment of the present invention, the method further comprises the step of displaying menu in smaller font when the distance between the remote control and the screen suddenly decreases.

With the above structure and method of the invention, the operator can intuitively complete relevant control over the imaging device at a distance.

### BRIEF DESCRIPTION OF THE DRAWINGS

FIG. 1 shows a hardware component block diagram of ultrasonic and radio nodes according to an embodiment of the present invention;

FIG. 2 shows a schematic diagram of communicating between ultrasonic and radio nodes;

FIG. 3 is a schematic diagram of a remote control system based on ultrasonic and radio ranging according to an embodiment of the present invention;

FIG. 4A shows a block diagram of the remote control shown in FIG. 3;

FIG. 4B shows a block diagram of an imaging device according to an embodiment of the present invention;

FIG. 5 is a flowchart of calculating the coordinate of the remote control of the invention;

FIG. 6A shows a block diagram of an imaging device according to another embodiment of the present invention;

FIG. 6B is the component block diagram of the ultrasonic and radio signal receiver of the imaging device as shown in FIG. 6A;

FIG. 7 shows a schematic diagram of determining the initial position of the projected coordinate according to an embodiment of the present invention;

FIG. 8 is a flowchart of initializing the position of the remote control of the invention;

FIG. 9 is a schematic diagram of adjusting the ratio between the moving distance in physical space of the remote control and the moving distance of the cursor on the screen according to the invention;

FIG. 10 is a schematic diagram of adjusting the ratio of the moving distance of the cursor on the screen with respect to the moving distance of the remote control based on the spatial distance between the remote control and the screen; and

FIG. 11 is a flowchart of utilizing the remote control to remotely control an imaging device.

### DETAILED DESCRIPTION OF THE PREFERRED EMBODIMENTS

Hereafter detailed description will be made to embodiments of the present invention with reference to accompanying drawings.

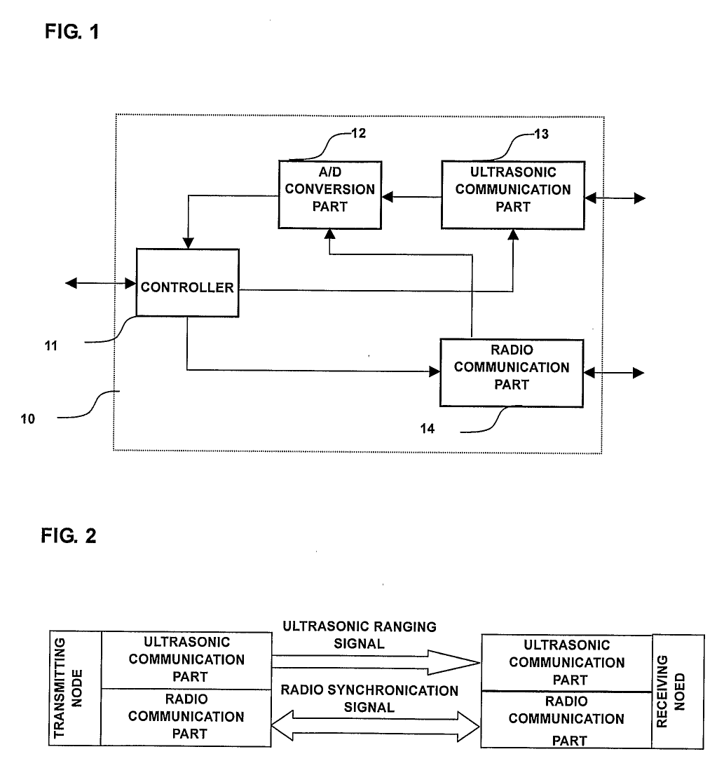

FIG. 1 shows a node having dual functions of ultrasonic and radio communication used in an embodiment of the invention.

As shown in FIG. 1, the ultrasonic and radio node includes a controller 11, an ultrasonic communication part 13 which makes ultrasonic communication with external under the control of the controller 11, an radio communication part 14 which makes radio communication with external under the control of the controller 11, an A/D conversion part 12 which converts analog signals from the ultrasonic communication part 13 and the radio communication part 14 into digital signals and sends them to the controller 11.

FIG. 2 shows a schematic diagram of the ultrasonic ranging of the invention. In the ultrasonic TDOA (Time Difference of Arrival) ranging, it is assumed that the transmitting node is the ultrasonic and radio signal transmitting party, and the receiving node is the receiving party, the process of ranging is as follows.

a) the transmitting node transmits radio synchronization signal and ultrasonic ranging signal simultaneously;

b) the receiving node starts timing when it receives the radio signal, and

records the initial time Tₛ;

c) the receiving node receives the ultrasonic ranging signal, records the receiving time Tₑ, and then calculates ultrasonic transmission time T_{D}=Tₑ−Tₛ;

d) calculating the distance D between the transmitting node and the receiving node by the following expression:

D=T_{D}×V_{sound} (1)

wherein V_{sound} is the velocity of ultrasonic wave.

In other words, the positioning node transmits RF signal and another low-speed signal (for example, ultrasonic wave etc.). The receiving node determines the distance between the positioning node and the receiving node by measuring the time difference between their arrival times.

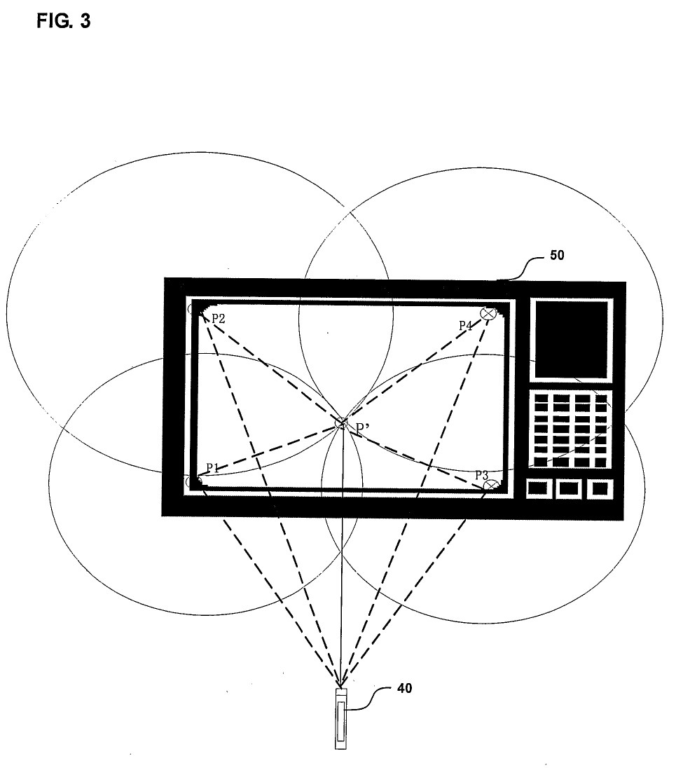

FIG. 3 is a schematic diagram of a remote control system based on ultrasonic and radio ranging according to an embodiment of the invention.

In order to control an imaging device, it is required to map the spatial position of a remote control onto the screen of the imaging device. In general, to determine the position of a remote control with respect to the screen, it needs to know the positions of at least three nodes in advance, and then determine the spatial position of the remote control according to the positioning algorithm of triangulation. Therefore, if it is possible to accurately measure the distances between the remote control (unknown node) and at least three known nodes, the spatial position of the remote control can be determined.

As shown in FIG. 3, the remote control system of the invention includes a remote control 40 which can simultaneously transmit radio signal (RF signal) and ultrasonic signal (US signal), and an imaging device 50 which includes an imaging device body and is equipped with ultrasonic and radio signal receivers P1˜P4 at the four corners of the screen. It is obvious that three ultrasonic and radio signal receivers can be selected, and further they can be installed at other positions of the screen, such as the edge of the screen, the corners or the edge of the imaging device, or they can be installed in the plane parallel to the screen.

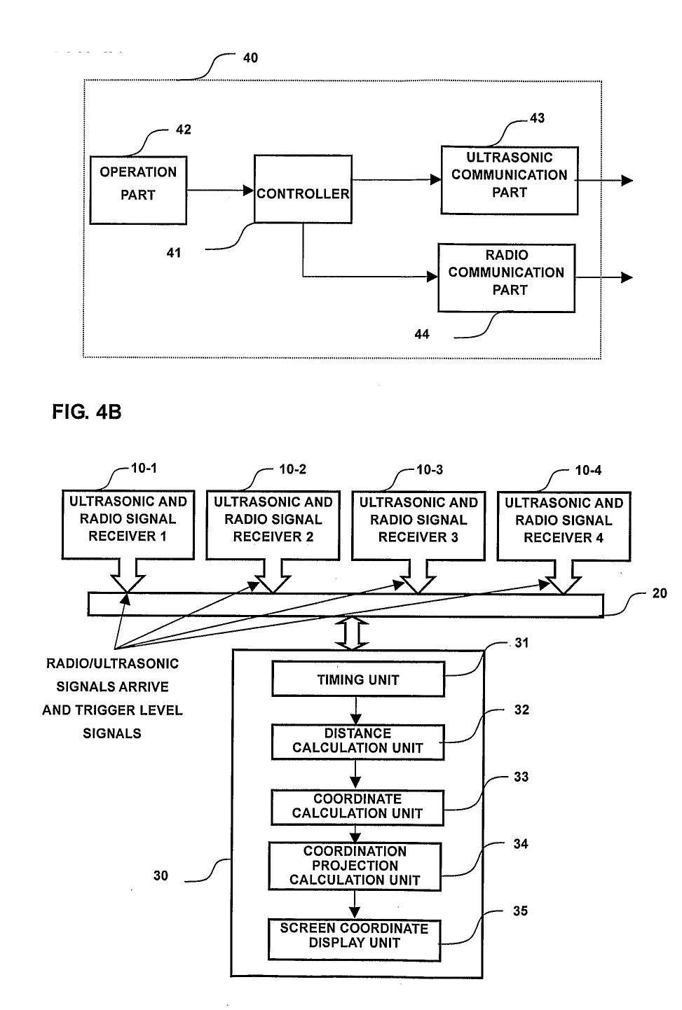

As shown in FIG. 4A, the remote control includes partial structure in the ultrasonic and radio node as shown in FIG. 1, for example, the controller 41, the ultrasonic communication part 43 and the radio communication part 44. Moreover, it is sufficient for the above ultrasonic communication part 43 and radio communication part 44 to have only the corresponding ultrasonic and radio signal transmitting functions respectively. In addition, the remote control 40 may include an operation part 42, such as a plurality of keys, to facilitate user input. In this way, when a user presses one of the keys on the remote control, for example, a predefined key, the controller 41 instructs the ultrasonic communication part 43 and the radio communication part 44 to transmit ultrasonic signal and radio signal simultaneously. The imaging device determines the spatial position of the remote control by receiving the ultrasonic signal and the radio signal.

FIG. 4B shows a block diagram of an imaging device according to the present invention, in which only partial structure relevant to the invention is shown for the purpose of clearness.

As shown in FIG. 4B, the imaging device 50 of the invention includes ultrasonic and radio signal receivers 1˜4 indicated as 10-1˜10-4 respectively, of which the specific structures is more or less the same as the ultrasonic and radio signal receiver 10 shown in FIG. 1 and which have only the ultrasonic and radio signal receiving function, a data signal bus 20 connected to the above ultrasonic and radio signal receivers 10-1˜10-4, and an imaging device processor 30 connected to the data signal bus 20 for processing the digital signal received from the data signal bus to map the position of the remote control into the cursor on the screen.

The imaging device processor 30 includes a timing unit 31 which starts timing when receiving radio signals from the respective ultrasonic and radio signal receivers and stops timing when receiving corresponding ultrasonic signals so as to obtain the time differences corresponding to the four ultrasonic and radio signal receivers respectively, a distance calculation unit 32 which obtains the distances between the four ultrasonic and radio signal receivers and the remote control 40 based on the time differences obtained by the timing unit 31, a coordinate calculation unit 33 which obtains the spatial position of the remote control 40 based on the four distances obtained by the distance calculation unit 32 and the positions of the ultrasonic and radio signal receivers, a coordinate projection calculation unit 34 which calculates the projected position of the remote control on the screen of the imaging device based on the spatial position of the remote control 40, and a screen coordinate display unit 35 which associates the projected position of the remote control on the screen of the imaging device with the cursor, for example, when the remote control moves left at a distance, the cursor is associated with the projected coordinate of the remote control and moved left at a corresponding distance.

In the above embodiment, the advantage lies in integrated processing module and simple implementation of hardware since the timing and calculating processes are carried out in the imaging device processor.

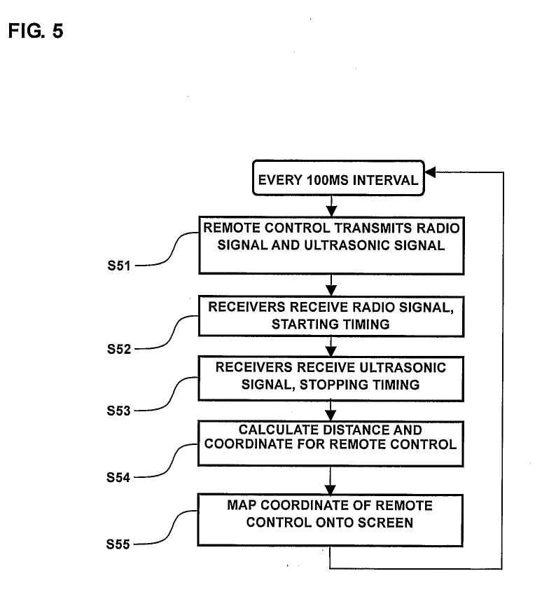

FIG. 5 shows a flowchart of calculating the coordinate of the remote control according to the present invention.

In the remote control's control over the imaging device, after a user presses the cursor key, the following mapping procedure is executed every predefined time, for example, 100 ms.

At S51, radio signal and ultrasonic signal are transmitted simultaneously from the ultrasonic communication part 43 and the radio communication part 44 of the remote control 40;

At S52, the radio signal arrives at the four receivers P1˜P4 provided on the screen and trigger the timing unit 31 in the imaging device processor 30 to start timing;

At S53, the ultrasonic signal arrives at the four receivers P1˜P4 provided on the screen and trigger the timing unit 31 in the imaging device processor 30 to stop timing, and the transmission time tᵢ, i=1, . . . , 4, is calculated by the timing unit 31;

At S54, the distance calculation unit 32 and the coordinate calculation unit 33 provided within the imaging device 50 calculate the coordinate of the remote control by the following expression:

$$\{ \begin{matrix}{( x - {x}_{1} )}^{2} + {( y - {y}_{1} )}^{2} + {( z - {z}_{1} )}^{2} = {( V \times {t}_{1} )}^{2} \\ {( x - {x}_{2} )}^{2} + {( y - {y}_{2} )}^{2} + {( z - {z}_{2} )}^{2} = {( V \times {t}_{2} )}^{2} \\ {( x - {x}_{3} )}^{2} + {( y - {y}_{3} )}^{2} + {( z - {z}_{3} )}^{2} = {( V \times {t}_{3} )}^{2} \\ {( x - {x}_{4} )}^{2} + {( y - {y}_{4} )}^{2} + {( z - {z}_{4} )}^{2} = {( V \times {t}_{4} )}^{2}\end{matrix} \qquad ( 2 )$$

wherein (xᵢ,yᵢ,zᵢ) represents the coordinate of the receiver (known), (x,y,z) represents the coordinate of the remote control to be measured, and V represents the travel speed of ultrasonic wave.

At S55, the coordinate projection calculation unit 34 of the imaging device maps the 3D coordinate of the remote control into the screen, and the coordinate is then converted into the cursor on the screen by the screen coordinate display unit 35.

In the present invention, four ultrasonic and radio signal receivers are provided on the screen so as to establish indeterminate static equation set for solving the 3D coordinate of the remote control 40. According to the preset condition, all the receivers are installed in the same plane, that is, the four receivers lies in the same plane as the screen or in the plane parallel to the screen. Thus, in the indeterminate static equation set, z₁, z₂, z₃ and z₄ satisfy the expression as follows:

z₁=z₂=Z₃=Z₄ (3)

Therefore, the indeterminate static equation set can be transformed into the following linear matrix equation set:

$$A {x}^{->} = {b}^{->} \\ wherein A = [ \begin{matrix}2 ( {x}_{1} - {x}_{4} ) & 2 ( {y}_{1} - {y}_{4} ) \\ 2 ( {x}_{2} - {x}_{4} ) & 2 ( {y}_{2} - {y}_{4} ) \\ 2 ( {x}_{3} - {x}_{4} ) & 2 ( {y}_{3} - {y}_{4} )\end{matrix} ] , \\ \vec{x} = [ \begin{matrix}x \\ y\end{matrix} ] , \\ {b}^{->} = [ \begin{matrix}{x}_{1}^{2} - {x}_{4}^{2} + {y}_{1}^{2} - {y}_{4}^{2} - {v}^{2} ( {t}_{1}^{2} - {t}_{4}^{2} ) \\ {x}_{2}^{2} - {x}_{4}^{2} + {y}_{2}^{2} - {y}_{4}^{2} - {v}^{2} ( {t}_{2}^{2} - {t}_{4}^{2} ) \\ {x}_{3}^{2} - {x}_{4}^{2} + {y}_{3}^{2} - {y}_{4}^{2} - {v}^{2} ( {t}_{3}^{2} - {t}_{4}^{2} )\end{matrix} ] \qquad ( 4 )$$

A residue vector is defined as

rᵢ=[2(xᵢ−x₄)x+2(yᵢ−y₄)]−bᵢ,i=1,2,3 (5)

Finding the least-square solution of the above indeterminate static equation (4) can be transformed as finding \vec{x} to minimize

$$F = {‖ r ‖}_{2}^{2} = {\sum }_{i = 1}^{m} {( 2 ( {x}_{i} - {x}_{4} ) x + 2 ( {y}_{i} - {y}_{4} ) - {b}_{i} )}^{2} .$$

To minimize F in the above expression is to find the minimum of F:

$$\begin{matrix}\begin{matrix}0 = \frac{\partial F}{\partial {x}_{k}} \\ = {\sum }_{i = 1}^{m} 2 ( {a}_{i 1} {x}_{1} + {a}_{i 2} {x}_{2} + … + {a}_{in} {x}_{n} - {b}_{i} ) {a}_{ik} \\ = 2 [ {\sum }_{i = 1}^{m} {a}_{ik} ( {a}_{i 1} {x}_{1} + {a}_{i 2} {x}_{2} + … + {a}_{in} {x}_{n} ) - {\sum }_{i = 1}^{m} {a}_{ik} {b}_{i} ] \\ = 2 [ {\sum }_{i = 1}^{m} {a}_{ik} ( {\sum }_{j = 1}^{n} {a}_{ij} {x}_{j} ) - {\sum }_{i = 1}^{m} {a}_{ik} {b}_{i} ] \\ = 2 [ {\sum }_{j = 1}^{n} ( {\sum }_{i = 1}^{m} {a}_{ij} {a}_{ik} ) {x}_{j} - {\sum }_{i = 1}^{m} {a}_{ik} {b}_{i} ] \\ k = 1 , 2 , … , n\end{matrix} & ( 6 ) \\ that is \\ {\sum }_{j = 1}^{n} ( {\sum }_{i = 1}^{m} {a}_{ij} {a}_{ik} ) {x}_{j} = {\sum }_{i = 1}^{m} {a}_{ik} {b}_{i} \\ k = 1 , 2 , … , n & \end{matrix}$$

the above expression is written in the following matrix form:

A^{T}Ax=A^{T}b (7)

The vector \vec{x} solved from the above expression is the least-square solution.

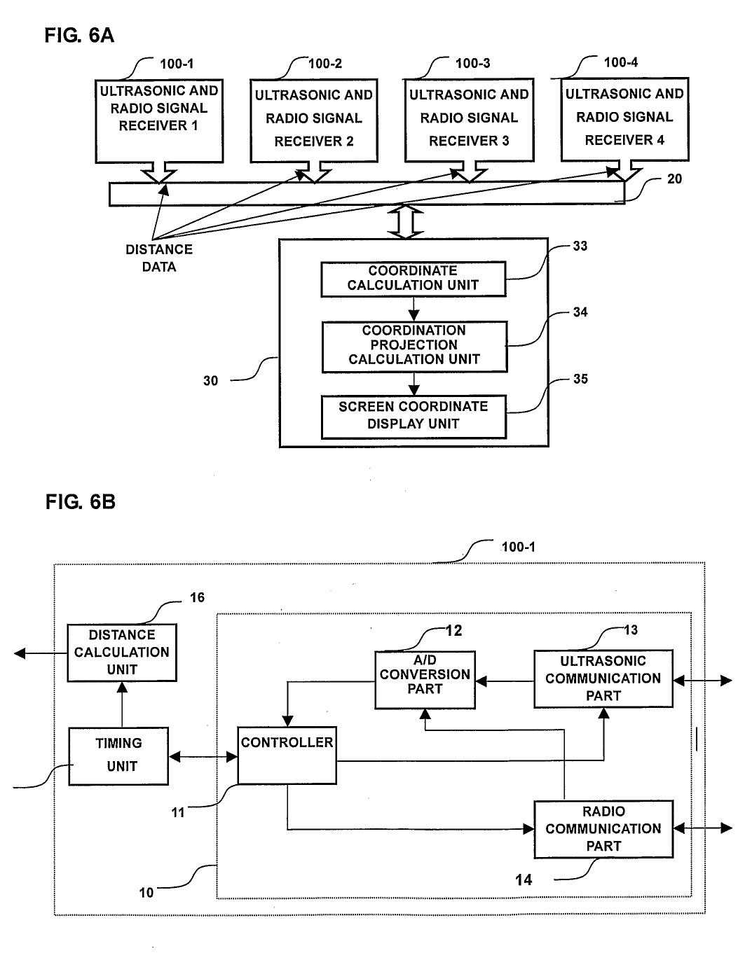

FIG. 6A shows a block diagram of an imaging device according to another embodiment of the invention.

FIG. 6B is a component block diagram of the ultrasonic and radio signal receivers in the imaging device shown in FIG. 6A. The system shown in FIG. 6A differs from the system shown in FIG. 4B in that part of the calculation function is transferred to the ultrasonic and radio signal receivers 100-1˜100-4, thereby avoiding the problem of poor ability to reflect signals in a real time manner.

As shown in FIG. 6A, in this embodiment the operations executed by the timing unit and the distance calculation unit are transferred to the ultrasonic and radio signal receivers 100-1˜100-4. In this way, the ultrasonic and radio signal receivers can transmit distance data directly to the imaging device processor 30 via the data signal bus 20.

As shown in FIG. 6B, in addition to the ultrasonic and radio node as shown in FIG. 1, the ultrasonic and radio signal receivers of this embodiment include a timing unit 15 which, under the control of a controller 11, starts time when receiving radio signal and stops timing when receiving ultrasonic signal to obtain the time differences of the respective receivers, and a distance calculation unit 16 which calculates the distances from the remote control to the four receivers based on the time differences obtained by the timing unit 15.

Then, in the imaging device processor 30, the same operations are carried out respectively in the coordinate calculation unit 33, the coordinate projection calculation unit 34 and the screen coordinate display unit 35. The detailed description will not be repeated here.

Further, when the physical spatial position of the remote control 40 is not located directly in front of the screen, the projection of the remote control will not fall into the screen. In this case, translation between the physical coordinate and the projected coordinate of the remote control is needed to ensure the remote control able to properly control the imaging device.

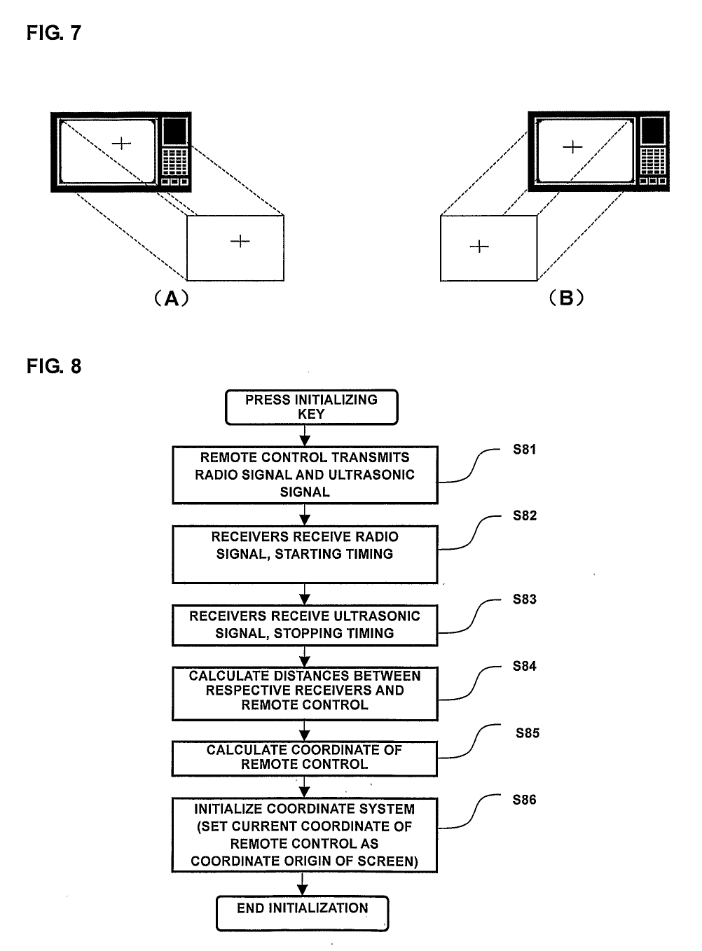

In the present invention, an initializing key is provided on the remote control 40. When an operator presses this key, the physical spatial coordinate of the remote control is mapped into the origin of the screen. Thus, as shown in FIG. 7, all the spatial movement of the remote control with respect to the press point of a key is transformed into the movement of the cursor on the screen with respect to the central point of the screen. Therefore it can be realized that an operator manipulates the imaging device at any angle.

FIG. 8 is a flowchart of initializing the position of the remote control of the invention. As shown in FIG. 8, when an operator presses the initializing key, radio and ultrasonic signals are transmitted simultaneously from the remote control at step S81. Then at step S82 the ultrasonic and radio signal receivers receive the radio signal and start the timing unit to perform timing. At step S83, the ultrasonic and radio signal receivers receive the ultrasonic signal, and the timing unit stops timing and obtains the times for the ultrasonic signal traveling from the remote control to the respective receivers.

Next, at step S84 the distance calculation unit calculates the distances between the remote control and the respective receivers, and the coordinate calculation unit calculates the coordinate value of the remote control at step S85.

Finally, at step S86, the imaging device processor 30 initializes the coordinate system, that is, maps the current coordinate of the remote control into the central point (origin) of the screen coordinate, and then ends the initializing procedure.

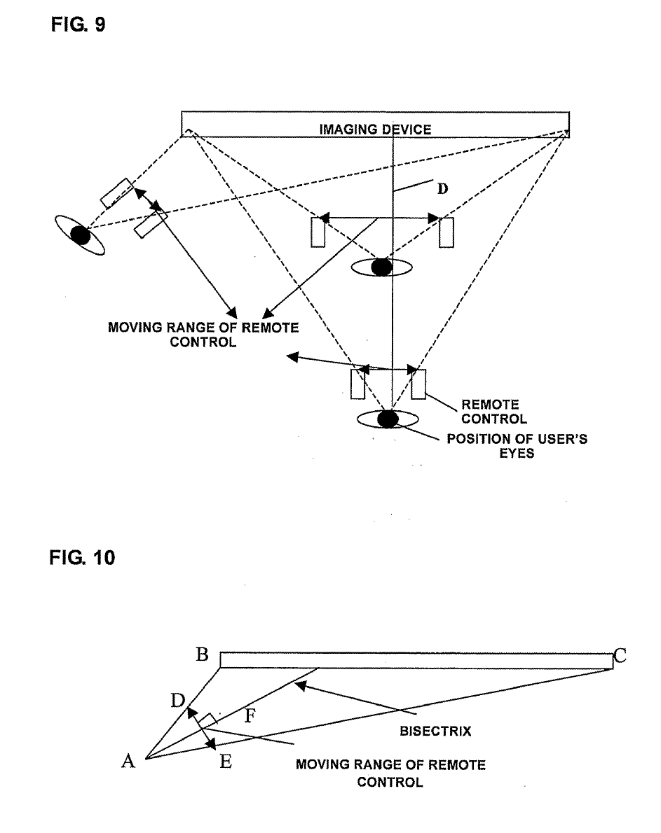

FIG. 9 is a schematic diagram of adjusting the ratio between the moving distance in physical space of the remote control and the moving distance of the cursor on the screen according to the invention.

As shown in FIG. 9, according to the use habit of an operator, when the operator holds the remote control 40 to operate at a distance, the moving range and the deflection angle of the remote control are small. When the operator performs a near operation (i.e. performing an operation with a small distance from the screen), the moving range and the deflection angle of the remote control are large. As a result, when the operator moves the remote control far and near, the moving distances of the cursor on the screen, which correspond to the same spatial distance of the remote control, are different. In other words, when operating the remote control nearby, the operator has to move a larger distance to reach the screen edge, while operating the remote control at a distance, the operator has difficulty in realizing a fine control over the moving distance of the screen cursor, since a small spatial translation of the remote control will lead to a relatively great movement of the screen cursor. Most operators cannot adapt themselves to the change in operation due to the distance difference from the screen.

In order to eliminate the change in operation due to the distance difference from the operator to the screen, the proportional relation between the moving distance of the screen cursor and the physical moving distance of the remote control can be adjusted using the Z-direction data in the spatial coordinate of the remote control, that is, the physical distance from the remote control to the screen. By expanding the proportion of the moving distance of the screen cursor with respect to the actual moving distance of the remote control at the time of a far operation and contracting the proportion of the moving distance of the screen cursor with respect to the actual moving distance of the remote control at the time of a near operation, the operator can conveniently and correctly control the screen cursor regardless of a far or near operation.

FIG. 10 is a schematic diagram of adjusting the ratio of the moving distance of the cursor on the screen with respect to the moving distance of the remote control based on the spatial distance between the remote control and the screen.

Taking the general case of operating on one side shown in FIG. 10 as example, analysis is made to the procedure of calculating the actual moving distance of the screen cursor with respect to the remote control based on the width of the screen and the distance from the remote control to the screen.

In FIG. 10, point A represents the position of the remote control, segment DE represents the moving range of the remote control, segment BC represents the screen width of imaging device, and line AF represents the bisectrix of the angle covered by the moving range of the remote control such that

$${BC}^{2} = {AB}^{2} + {AC}^{2} - 2 AB \cdot AC \cdot cos ∠ B A C$$

$$that is , cos ∠ B A C == \frac{{AB}^{2} + {AC}^{2} - {BC}^{2}}{2 AB \cdot AC}$$

$$and ∠ B A C == {cos}^{- 1} ( \frac{{AB}^{2} + {AC}^{2} - {BC}^{2}}{2 AB \cdot AC} )$$

$$tg ( \frac{∠ B A C}{2} ) = \frac{DF}{AF} = \frac{FE}{AF}$$

and the result is

$$r = \frac{DE}{BC} = \frac{DF + FE}{BC} = \frac{2 AF \cdot tg ( \frac{∠ B A C}{2} )}{BC}$$

AF in the above expression can be a predefine value, for example, 50 cm.

Although the previous analysis discusses only the proportion adjustment along the width direction of the screen, the same principle can be applicable to the proportion adjustment along the height direction of the screen.

Moreover, as the functions of current digital TVs keep growing, the content of operation menu is expanding. As a result, a large number of characters are frequently to be encountered when the menu of a digital TV is under operation. To ensure users to watch TV programs at the time of operation without any interference, some TV manufacturers usually make menu displayed in a translucent form, which further improves the menu definition when the user performs a remote operation. However, if the characters of menu are displayed fixedly in large font, adverse visual effect will be imposed on a near operation.

In the present invention, using the distance from the remote control to the screen, the display proportion of menu can be automatically adjusted by means of the display unit within the imaging device. The menu can be display in larger font when operating the remote control at a distance, while the font of menu can be gradually reduced as the operation distance becomes shorter, thereby providing a convenient and intuitive operation interface for users. Of course, when the remote control held by an operator moves suddenly from a position near the screen to a position far from the screen or from a position far from the screen to a position near the screen, the imaging device can make a response in time and display menu in larger or smaller font. Alternatively, since the configuration of the invention enables to measure the distance between the remote control and the screen, the menu can be display in corresponding font when the distance thereof is shorter than a threshold value or within a predefined range.

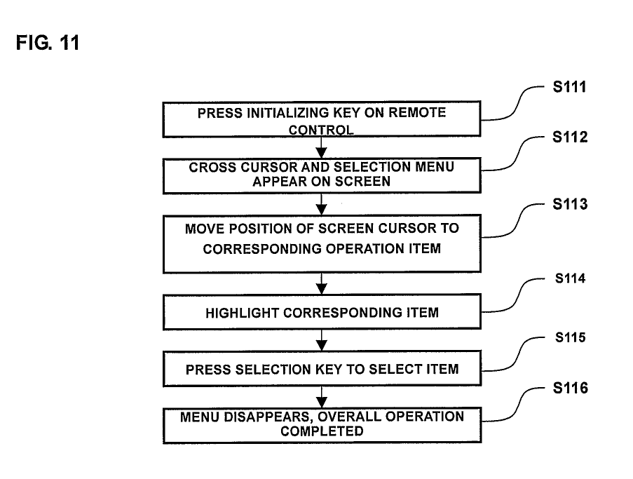

FIG. 11 is a flowchart of utilizing the remote control to remotely control an imaging device. At step S111, an operator presses the initializing key on the remote control. At step S112, a cross cursor and a selection menu appear on the screen. Then at step S113, the operator moves the remote control to move the cursor on the screen to the corresponding operation item.

Next, at step S114, the item to which the cursor has been moved is highlighted. Then at step S115, the operator presses the selection key to select the highlighted item. Finally, at step S116, the operator presses the exit key, and the menu disappears. The overall operation is completed.

The embodiments of the invention are mentioned above and the scope of the invention is not limited thereto. For any skilled in the art, it is understood that any variation or substitute easily conceivable should be encompassed in the technological scope disclosed in the invention. Thus, the scope of the invention should be defined by the claims.

What is claimed is:

1. A remote control comprising:
an operation means having a plurality of keys,
an ultrasonic and radio signal transmitting means for transmitting radio signals and ultrasonic signals while one of the plurality of keys is operated so as to map the position of the remote control into a cursor displayed on a screen, and
a control means for controlling the operation means and the ultrasonic and radio signal transmitting means.

2. The remote control of claim 1, wherein the operation means includes an initializing key, and when the initializing key is pressed, the current position of the remote control is mapped into the central point of the screen.

3. The remote control of claim 1 or 2, wherein the ultrasonic and radio signal transmitting means includes a radio signal transmitting unit for transmitting radio signals under the control of the control means, and an ultrasonic signal transmitting unit for transmitting ultrasonic signals in synchronization with the radio signals under the control of the control means.

4. An imaging device comprising:
at least three ultrasonic and radio signal receiving means configured at the predefined position in the same plane as a screen or in the plane parallel to the screen for receiving radio signals and ultrasonic signals transmitted from a remote control,
a timing means for starting timing when the ultrasonic and radio signal receiving means receives radio signals and stopping timing when the ultrasonic and radio signal receiving means receives ultrasonic signals so as to obtain a time difference corresponding to the respective ultrasonic and radio signal receiving means,
a calculation means for calculating the spatial coordinate of the remote control and the projected coordinate of the spatial coordinate on the screen based on the time difference, and
a display means for associating the projected coordinate with the cursor displayed on the screen.

5. The imaging device of claim 4, wherein the calculation means includes:
a distance calculation unit for calculating the distance between the respective ultrasonic and radio signal receiving means and the remote control based on the time difference corresponding to the respective ultrasonic and radio signal receiving means,
a coordinate calculation unit for calculating the spatial coordinate of the remote control based on the distance between the respective ultrasonic and radio signal receiving means and the remote control, and
a coordinate projection calculation unit for calculating the projected coordinate on the screen based on the spatial coordinate of the remote control.

6. The imaging device of claim 5, wherein the distance calculation unit calculates the distance based on the following expression:
Dᵢ=T_{Di}×V_{sound}
wherein T_{Di} represents the time taken to transmit ultrasonic signals from the remote control to the respective ultrasonic and radio signal receiving means, and V_{sound} represents the velocity of ultrasonic wave.

7. The imaging device of claim 5 or 6, wherein when the distance between the remote control and the screen increases, the display means expands the proportion of the moving distance of the screen cursor with respect to the actual moving distance of the remote control.

8. The imaging device of claim 5 or 6, wherein when the distance between the remote control and the screen decreases, the display means contracts the proportion of the moving distance of the screen cursor with respect to the actual moving distance of the remote control.

9. The imaging device of claim 4, wherein when the distance between the remote control and the screen, increases, the display means displays menu in larger font.

10. The imaging device of claim 4, wherein when the distance between the remote control and the screen decreases, the display means displays menu in smaller font.

11. The imaging device of claim 4, wherein when the distance between the remote control and the screen suddenly increases, the display means displays menu in larger font.

12. The imaging device of claim 4, wherein when the distance between the remote control and the screen suddenly decreases, the display means displays menu in smaller font.

13. A remote control system comprising the remote control of claim 1 and the imaging device of claim 4.

14. A remote control method used in a system comprising a remote control and an imaging device, wherein the remote control includes a ultrasonic and radio signal transmitter, and the imaging device is configured with at least three ultrasonic and radio signal receivers at the predefined position in the same plane as the screen or in the plane parallel to the screen, the method comprises the steps of:
transmitting simultaneously both radio signals and ultrasonic signals from the ultrasonic and radio signal transmitter,
starting timing when the ultrasonic and radio signal receivers receive radio signals and stopping timing when the ultrasonic and radio signal receivers receive ultrasonic signals so as to obtain the time difference corresponding to the respective ultrasonic and radio signal receivers,
calculating the spatial coordinate of the remote control and the projected coordinate of the spatial coordinate on the screen based on the time difference, and
associating the projected coordinate with the cursor displayed on the screen.

15. The method of claim 14, wherein the step of calculating the spatial coordinate of the remote control and the projected coordinate of the spatial coordinate on the screen based on the time difference includes:
calculating the distance between the respective ultrasonic and radio signal receivers and the remote control based on the time difference corresponding to the respective ultrasonic and radio signal receivers,
calculating the spatial coordinate of the remote control based on the distance between the respective ultrasonic and radio signal receivers and the remote control, and
calculating the projected coordinate on the screen based on the spatial coordinate of the remote control.

16. The method of claim 14, wherein the calculation of the distance is based on the following expression:
Dᵢ=T_{Di}×V_{sound}
wherein T_{Di} represents the time for transmitting ultrasonic signals from the remote control to the respective ultrasonic and radio signal receivers, and V_{sound} represents the velocity of ultrasonic wave.

17. The method of claim 14, further comprises the step of expanding the proportion of the moving distance of the screen cursor with respect to the actual moving distance of the remote control when the distance between the remote control and the screen increases.

18. The method of claim 14, further comprises the step of contracting the proportion of the moving distance of the screen cursor with respect to the actual moving distance of the remote control when the distance between the remote control and the screen decreases.

19. The method of claim 14, further comprises the step of displaying menu in larger font when the distance between the remote control and the screen increases.

20. The method of claim 14, further comprises the step of displaying menu in smaller font when the distance between the remote control and the screen decreases.

21. The method of claim 14, further comprises the step of displaying menu in larger font when the distance between the remote control and the screen suddenly increases.

22. The method of claim 14, further comprises the step of displaying menu in smaller font when the distance between the remote control and the screen suddenly decreases.
